(19) United States
(12) Patent Application Publication
(10) Pub. No.: US 2024/0037886 A1
(43) Pub. Date: Feb. 1, 2024

(54) ENVIRONMENT SHARING

(71) Applicant: Apple Inc., Cupertino, CA (US)

(72) Inventors: Shih-Sang Chiu, Menlo Park, CA (US); Alexandre Da Veiga, San Francisco, CA (US); David H. Huang, San Mateo, CA (US); Jonathan Perron, Felton, CA (US); Jordan A. Cazamias, San Francisco, CA (US)

(21) Appl. No.: 18/380,399

(22) Filed: Oct. 16, 2023

Related U.S. Application Data
(63) Continuation of application No. PCT/US2022/026973, filed on Apr. 29, 2022.
(60) Provisional application No. 63/184,483, filed on May 5, 2021.

(51) Int. Cl. G06T 19/20; G06T 17/05

(52) U.S. Cl. CPC G06T 19/20; G06T 17/05; G06T 2219/2024

(57) ABSTRACT

Various implementations disclosed herein include devices, systems, and methods that generate and share/transmit a 3D representation of a physical environment during a communication session. Some of the elements (e.g., points) of the 3D representation may be replaced to improve the quality and/or efficiency of the modeling and transmitting processes. A user's device may provide a view and/or feedback during a scan of the physical environment during the communication session to facilitate accurate understanding of what is being transmitted. Additional information, e.g., a second representation of a portion of the physical environment, may also be transmitted during a communication session. The second representations may represent an aspect (e.g., more details, photo quality images, live, etc.) of a portion not represented by the 3D representation.

### CROSS-REFERENCE TO RELATED APPLICATIONS

This application is a continuation of International Application No. PCT/US2022/026973 filed Apr. 29, 2022, which claims the benefit of U.S. Provisional Application No. 63/184,483 filed May 5, 2021, entitled “ENVIRONMENT SHARING,” each of which is incorporated herein by this reference in its entirety.

### TECHNICAL FIELD

The present disclosure generally relates to electronic devices that use sensors to provide views during communication sessions, including views that include representations of the physical environments of the users participating in the sessions.

### BACKGROUND

Communication sessions such as video conferences, interactive gaming sessions, and other interactive social experiences enable users to share 2D images of their physical environments. For example, web-based video conferencing technologies enable users to simultaneously share 2D images and video of themselves within their physical environments. Existing techniques do not adequately facilitate sharing 3D environments during communication sessions.

### SUMMARY

Various implementations disclosed herein include devices, systems, and methods that generate and share/transmit a 3D representation of a physical environment during a communication session. Some of the elements of the 3D representation (e.g., points of a point cloud, or points or polygons of a mesh) may be replaced to improve the quality and/or efficiency of the modeling and transmitting processes. For example, some elements may be replaced with non-point/non-polygon elements, e.g., planar elements, geometric shell elements, etc. Scene understanding semantics may be used to determine which elements of the 3D representation to replace. In some implementations, elements representing portions of the walls, ceiling, and floor of a physical environment may be replaced with planar elements or a geometric shell corresponding to a basic shape of multiple perimeter regions of the physical environment. In contrast, other elements representing furniture, curtains, wall hangings, etc. remain included in the 3D representation. Selectively altering the 3D representation to replace certain elements may provide a cleaner feeling, a more solid feeling, a more enclosed feeling, and/or a lighter feeling environment. Altering the 3D representation may additionally provide a more compact 3D representation for more efficient and faster communication and rendering.

In some implementations, a processor performs a method by executing instructions stored on a computer readable medium. The method generates a 3D representation (e.g., a 3D point cloud) of a physical environment. The 3D representation has elements (e.g., points) each having a 3D location and representing an appearance (e.g., color) of a portion of the physical environment. The method determines object types (e.g., a semantic label such as “wall”) for the elements of the 3D representation. In some implementations, this involves using a machine learning model to provide scene understanding-based semantic labels (e.g., table, couch, wall, etc.) for the elements of a 3D representation. In accordance with determining the object types for the elements of the 3D representation, the method replaces a first set of the elements of the 3D representation that correspond to a first object type with a visual feature. A second set of the elements of the 3D representation that do not correspond to the first object type remains in the 3D representation. In one example, this involves replacing wall elements with a planar element. In another example, this involves replacing room boundary elements (e.g., walls, ceiling, floor) with a geometric shell, e.g., an empty 3D shape such as a 3D rectangle for a rectangular room. The color and/or texture of the visual feature may be determined based on assessing the physical environment, e.g., via texture matching. The replacement may reduce the size of the 3D representation, e.g., potentially replacing hundreds or thousands of elements with a relatively small number of visual features. The method provides a view of the 3D representation including the second set of elements and the visual feature. Thus, for example, user views may be based on the remaining elements of the 3D representation depicting a couch, curtains, tables, etc. and a geometric shape such as a semantic shell representing the boundary portions of a room.

Various implementations disclosed herein include devices, systems, and methods that generate and share/transmit a 3D representation of a physical environment during a communication session. Sensor data obtained by a user device, e.g., during a scan, of the physical environment during the communication session is used to generate the 3D representation. The user's device may provide a view and/or feedback during the scan to facilitate accurate understanding of what is being transmitted. For example, the user's view as he or she scans the environment may show the physical environment with a graphical indication distinguishing a portion that is included/transmitted as part of the 3D representation from a portion that is not included/transmitted as part of the 3D representation. The user may move the device around to include/transmit more or less of the physical environment and a “painting effect” may provide feedback regarding the change with respect to what is being included/transmitted. Additionally, the user may provide input that may be used to set boundaries or otherwise reduce what will be transmitted, e.g., selecting certain objects or regions of the physical environment that will not be transmitted.

In some implementations, a processor performs a method by executing instructions stored on a computer readable medium. The method obtains sensor data during a scan of a physical environment during a communication session. For example, this may involve obtaining images and depth data during a communication session in which a host starts sharing/transmitting his or her environment with other users. The method alters a 3D representation (e.g., a 3D point cloud) of the physical environment during the scan based on the sensor data, where the altering changes which portions of the physical environment are represented in the 3D representation. In accordance with altering the 3D representation, a graphical indication is updated in a view of the physical environment provided during the scan. The graphical indication corresponds to a boundary between a first portion of the physical environment represented in the 3D representation and a second portion of the physical environment unrepresented in the 3D representation. The 3D representation is transmitted during the communication session, which may enable a receiving electronic device to provide a view of the 3D representation.

Various implementations disclosed herein include devices, systems, and methods that generate and transmit a 3D representation of a physical environment during a communication session. Based on a user action, additional content is used to supplement that 3D representation. For example, more detailed or live content (e.g., images) may be positioned in place of or in front of a portion of the 3D representation in a view. In one example, live image content of a record player may be included in front of a portion of a 3D representation of the record player to provide a higher-fidelity representation and/or live content, e.g., showing the spinning record.

In some implementations a processor performs a method by executing instructions stored on a computer readable medium. The method generates a 3D representation (e.g., a 3D point cloud) of a physical environment. The method transmits the 3D representation during the communication session. The method further transmits a second representation of a portion of the physical environment during the communication session.

The second representation may provide a more detailed view than the 3D representation. The second representation may be displayed concurrently with the 3D representation. The second representation may include an image or video of the portion of the physical environment and positional data specifying positioning of the second representation relative to the 3D representation. The second representation may be displayed on its own, for example, as a “window” into another user's world. This may involve positioning the second representation based on constraints in a way that preserves some spatial continuity. For example, the second representation can be presented in front of the presenting user (or representation thereof) to indicate the direction of the part of the world he or she is transmitting using the second representation. In another example, the second representation can be presented with a spatial offset (e.g., distance and angle) relative to the presenting user (or representation thereof) that matches the spatial offset between the presenting user and the part of the world he or she is transmitting using the second representation. In other examples, the second representation can be displayed in place of the presenting user (or avatar), at a predefined offset from the avatar, overlaid on the avatar, in a location controlled by the viewing user (e.g., app window, hand, etc.), or using alternative or additional presentation location selection criteria.

In some implementations, the second representation represents an aspect (e.g., more details, photo quality images, live, etc.) of the portion not represented by the 3D representation. The second representation may be image data, live data, camera pass through images, a more-detailed 3D representation, etc.

In some implementations, the transmitting is based on user input. For example, this may involve identifying input (e.g., the host pointing at the record player), identifying an object based on the input, and, based on identifying the object, determining to transmit the second representation.

In some implementations, the method provides a view of the physical environment based on the 3D representation and the view includes the second representation of the portion of the physical environment. In some implementations, the second representation is positioned based on a position of a corresponding representation of the portion in the 3D representation, e.g., in front of or in place of corresponding points of a point cloud. Such positioning may involve adjusting an angle of an image portal based on the viewpoint into the 3D environment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates exemplary an electronic device operating in a physical environment during a communication session in accordance with some implementations.

FIG. 2 illustrates a depiction of a 3D representation of the physical environment of FIG. 1 in accordance with some implementations.

FIG. 3 illustrates a view of the 3D representation of FIG. 2 with some elements replaced with visual features in accordance with some implementations.

FIG. 4 illustrates a view of the 3D representation of FIG. 2 with some elements replaced with visual features and a visual feature provided with a texture based on the physical environment in accordance with some implementations.

FIG. 5 illustrates an additional representation used to provide an additional aspect of an object depicted in the view of FIG. 4 in accordance with some implementations.

FIG. 6 illustrates feedback provided during a scan during a communication session in accordance with some implementations.

FIG. 7 is a flowchart illustrating a method for generating and transmitting a 3D representation of a physical environment during a communication session in accordance with some implementations.

FIG. 8 is a flowchart illustrating a method for providing feedback in a scan of a physical environment during a communication session in accordance with some implementations.

FIG. 9 is a flowchart illustrating a method for providing an additional aspect of an object depicted in a 3D representation during a communication session in accordance with some implementations.

FIG. 10 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

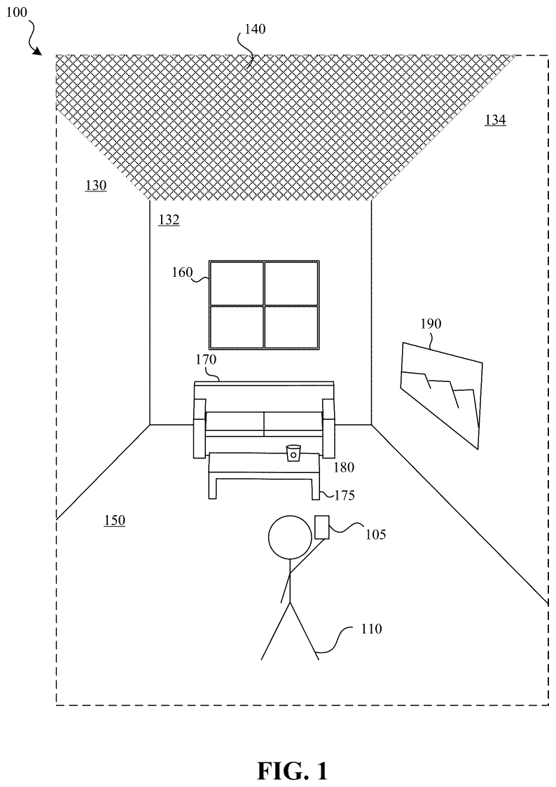

FIG. 1 illustrates an exemplary electronic device 105 operating in a physical environment 100 during a communication session, e.g., while the electronic device 105 communicates with one or more other electronic devices (not shown) which are transmitting information with one another or an intermediary device such as a communication session server. In this example of FIG. 1, the physical environment 100 is a room that includes walls 130, 132, 134, ceiling 140, floor 150, window 160, couch 170, table 175, coffee cup 180, and wall hanging 190. The electronic device 105 includes one or more cameras, microphones, depth sensors, or other sensors that can be used to capture information about and evaluate the physical environment 100 and the objects within it, as well as information about the user 110 of the electronic device 105. The information about the physical environment 100 and/or user 110 may be used to provide visual and audio content during the communication session. For example, a communication session may provide views to one or more participants (e.g., user 110 and/or other participants not shown) of a 3D environment that is generated based on camera images and/or depth camera images of the physical environment 100 as well as a representation of user 110 based on camera images and/or depth camera images of the user 110.

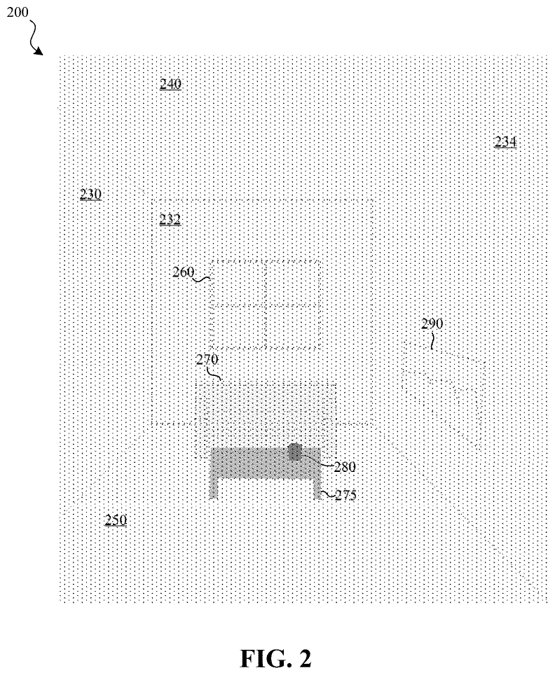

FIG. 2 illustrates a depiction 200 of a 3D representation of the physical environment 100 of FIG. 1. In this example, points 230 correspond to wall 130, points 232 correspond to wall 132, points 234 correspond to wall 134, points 240 correspond to ceiling 140, points 250 correspond to floor 150, points 260 correspond to window 160, points 270 correspond to couch 170, points 275 correspond to table 175, points 280 correspond to coffee cup 180, and points 290 correspond to wall hanging 190. Note that an actual 3D representation (e.g., 3D point cloud, 3D mesh, etc.) may have more variable, less consistently spaced element locations, more or fewer elements or otherwise differ from the depiction 200 which is provided as an illustration rather than an accurate portrayal of an actual 3D point cloud. Points of a 3D representation, for example, may correspond to depth values measured by a depth sensor and thus may be more sparse for objects farther from the sensor than for objects closer to the sensor. Each of the points of the 3D representation corresponds to a location in 3D a coordinate system and has a characteristic (e.g., color) indicative of an appearance of a corresponding portion of the physical environment 100. In some implementations, an initial 3D representation is generated based on sensor data and then an improvement process is performed to improve the 3D representation, e.g., by filling holes, performing densification to add points to make the representation denser, etc.

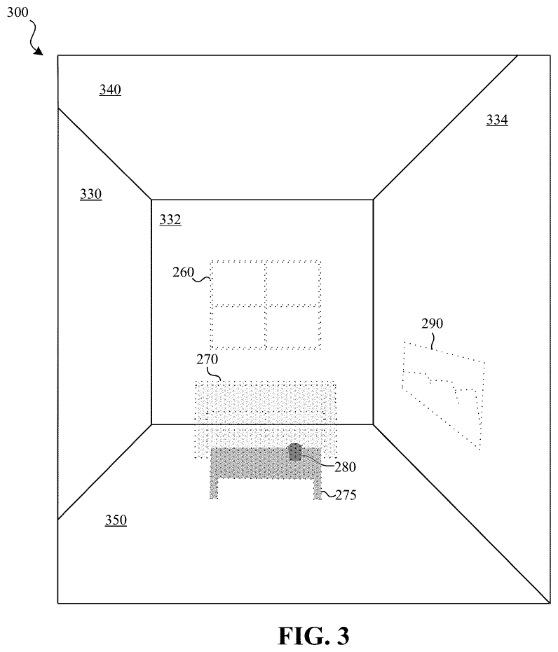

FIG. 3 illustrates a view of the 3D representation of FIG. 2 with some elements replaced with visual features. Points 230 corresponding to wall 130 have been replaced with a planar element 330. Points 232 corresponding to wall 132 have been replaced with a planar element 332 (except for points 260 which correspond to a frame of window 160). Points 234 corresponding to wall 134 have been replaced with a planar element 334, except for points 290 corresponding to wall hanging 190. Points 240 corresponding to ceiling 140 have been replaced with a planar element 340. Points 250 corresponding to floor 150 have been replaced with a planar element 350. In some implementations, planar elements are used individually to represent perimeter regions (e.g., walls, ceilings, floors) of a physical environment. In other implementations, alternative geometric shapes are used. For example, a shell of a 3D shape or portion thereof (e.g., 5 interior surfaces of a rectangular cube) are used to replace corresponding perimeter regions of a room or other physical environment. In some implementations, the device determines a room layout based on sensor data and selects a replacement geometric shape based on the room layout.

In the example of FIG. 3, while points 230, 232, 234, 240, 250 are replaced with planar elements, other points (e.g., points 270 representing the couch, points 275 representing the table 175, and points 280 representing the coffee cup 180) remain included within the 3D representation. The view 300 is provided based on these remaining points 270, 275, 280 and the planar elements 330, 332, 334, 340, 350 (or other visual feature). For example, the 3D representation may include or be associated with the planar elements and this information may be provided during the communication session to a rendering engine on device 105 or other devices involved in the communication session. Providing the 3D representation to other devices involved in the communication session may allow users of those devices to feel as though they are in the same physical environment 100 as user 110. The points and planar element information is used to provide a view that includes both, e.g., as illustrated in the view 300 of FIG. 3.

Selectively altering the 3D representation to replace certain points, as illustrated in FIG. 3, may provide a cleaner feeling, a more solid feeling, a more enclosed feeling, and/or a lighter feeling environment. Altering the 3D representation may additionally provide a more compact 3D representation for more efficient and faster communication and rendering.

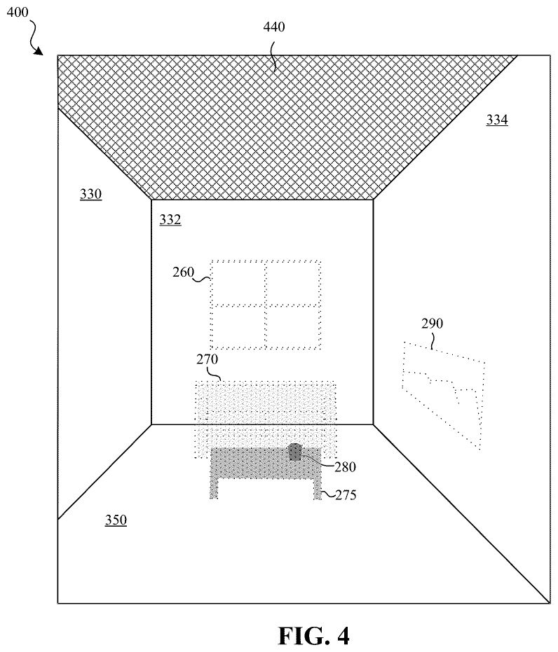

FIG. 4 illustrates a view 400 of the 3D representation of FIG. 2 with some points replaced with visual features (e.g., planar elements, geometric elements, shell, etc.) where a visual feature is provided with a texture based on the physical environment. Specifically, the planar element 440 has a texture that is generated based on the appearance of the ceiling 140 (see FIG. 1). For example, such a texture may be identified by analyzing a portion of an image corresponding to the ceiling 140 portion of the physical environment 100. A texture may be stored using less data that dense point data corresponding to the appearance of the texture. For example, a texture may be stored using a representation that simplifies repeating elements within a pattern.

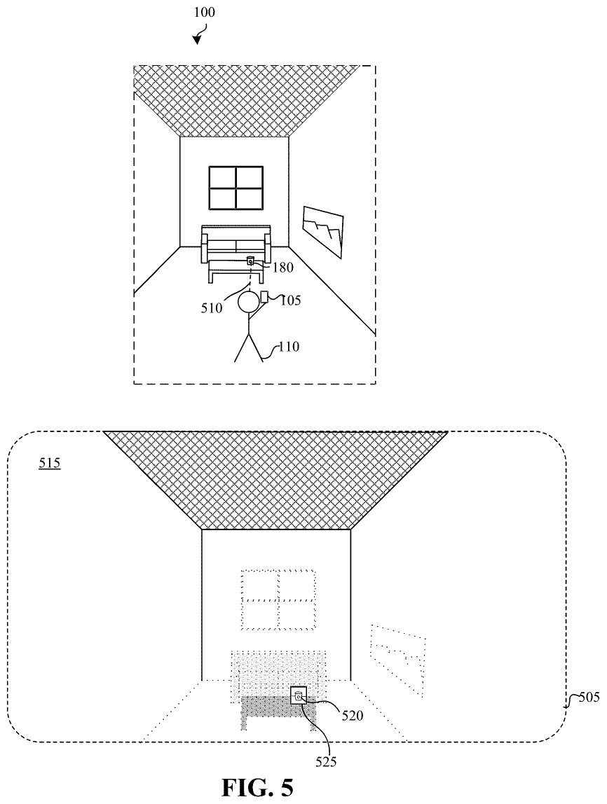

FIG. 5 illustrates an additional representation 520 used to provide an additional aspect of an object (i.e., coffee cup 180). Specifically, in this example, the additional representation 520 is an image of the coffee cup 180 that is provided along with the 3D representation and used to display a better representation of the coffee cup 180 than provided by the points of the 3D representation. The additional representation 520 may include better quality (e.g., image pixels that are denser than points of a 3D point cloud) image data, live data, camera-pass through images/video, a more detailed 3D representation, and/or other information that enables a more detailed depiction 525 of the coffee cup 180.

In some implementations, providing the additional representation 520 is based on user input. For example, this may involve identifying input (e.g., a user pointing at the coffee cup or having a gaze direction 510 corresponding to the coffee cup 180), identifying the coffee cup 180 based on the input, and, based on identifying the object, determining to transmit the additional representation 520.

FIG. 5 provides a view 515 of the physical environment 100 presented by device 505 (corresponding to device 105 or another device in a communication session with device 105) based on the 3D representation (including one or more 3D elements, visual features, or a combination thereof) and the view includes an additional representation 520 of a specific portion of the physical environment 100. In some implementations, the additional representation 520 is positioned based on a position of a corresponding representation of the portion in the 3D representation, e.g., in front of or in place of corresponding points 280 of a point cloud corresponding to the coffee cup 180. Such positioning may involve adjusting an angle of an image portal based on the viewpoint into the 3D environment. For example, if the user 110 were standing a few feet to the left, the additional representation 520 may be rotated at its 3D position for better viewing from the user's viewpoint. The additional representation 520 can be presented alone or in combination with the 3D representation. In some implementations, the additional representation 520 may be positioned based on constraints in a way that preserves some spatial continuity. For example, the additional representation 520 can be presented by other participants in the communication session in front of the user of device 105 (or representation thereof) to indicate the direction of coffee cup 180 in physical environment 100. In another example, the additional representation 520 can be presented by other participants in the communication session with a spatial offset (e.g., distance and angle) relative to the user of device 105 (or representation thereof) that matches the spatial offset between the user of device 105 and coffee cup 180 in physical environment 100. In other examples, the additional representation can be displayed in place of the presenting user (or avatar), at a predefined offset from the avatar, overlaid on the avatar, in a location controlled by the viewing user (e.g., app window, hand, etc.), or using alternative or additional presentation location selection criteria.

In yet other implementations, the additional representation can be presented by other participants in the communication session in lieu of the user of device 105 (or representation thereof, at a predefined offset from the user of device 105 (or representation thereof), overlaid on the user of device 105 (or representation thereof), in a location controlled by the other participant (e.g., an application window, attached to a body part of the other participant, etc.), or the like.

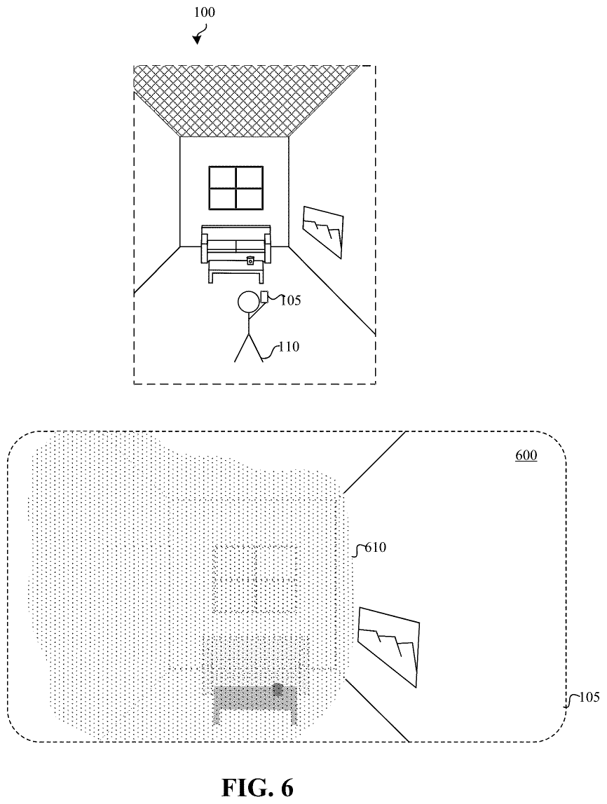

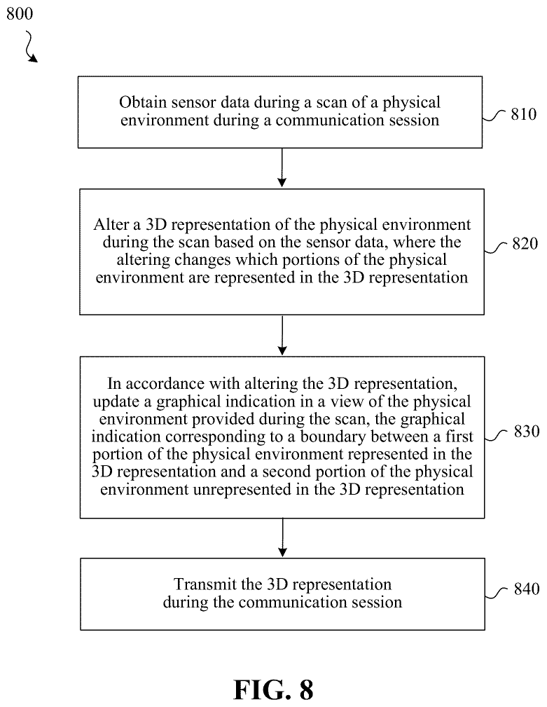

In some implementations, since device 105 is located in physical environment 100, device 105 may present a direct view of physical environment 100 through a transparent/translucent display or may present a pass-through image of physical environment 100 using an opaque display without displaying any of the 3D representation (e.g., 3D point cloud, 3D mesh, or visual feature(s)) of physical environment 100. In these implementations, device 105 may present images or representations (e.g., avatars) of other users in a communication session with device 105 overlaid on the direct or indirect view of physical environment 100. Device 105 may also display virtual objects (e.g., an application window, virtual board game, etc.) that are part of the communication session. In some implementations, device 105 may instead present a direct or indirect view of physical environment 100 along with a graphical indication of which portion(s) of physical environment 100 is being transmitted to/shared with other participants of the communication session as described in greater detail below with respect to FIGS. 6 and 8. Devices of other users in the communication session, however, may present a view of physical environment 100 using the 3D representation alone or in combination with a direct or indirect view of their own physical environment. For example, devices of other users in the communication session may present a view of physical environment 100 similar or identical to view 515 or may present a view of physical environment 100 similar to view 515 overlaid on a direct (e.g., via a transparent/translucent display) or pass-through image of their own environment. These devices may also display an image or representation of other users (e.g., user 110) or virtual objects that are part of the communication session.

FIG. 6 illustrates feedback provided during a scan during a communication session. In this example, user 110 uses device 105 to scan the physical environment 100 during a communication session. The scan may be intentional or un-intentional, guided or unguided, limited in duration or ongoing. During the scan (and/or within the communication session), the device 105 displays feedback regarding the scan to provide information about which portions of the physical environment 100 will be and/or are being depicted by a transmitted 3D representation and which portions will not be depicted. For example, device 105 provides view 600 including a boundary 610 around a first portion of the physical environment 100 that is included in the 3D representation and thus that will be transmitted within the communication session. A second portion of the physical environment 100 outside of the boundary 610 is identified by the boundary as not being included/transmitted. Moreover, the first portion (within the boundary 610) may be distinguished, e.g., by being represented using elements (e.g., points) of the 3D representation and/or using a distinctive visual characteristic (e.g., color, highlighting, etc.). As the user moves device 105 and obtains sensor data corresponding to previously unscanned parts of the physical environment 100, the 3D representation can be updated and transmitted during the communication session. The boundary 610 may change its position to show the additions to the 3D representation. In some implementations, the feedback provides a painting effect in which the user moves the device 105 to capture sensor data that modifies the 3D representation while seeing feedback that paints corresponding represented portions of the physical environment in the view 600 with a distinctive visual characteristic.

In the example of FIGS. 1-6, the electronic device 105 was illustrated as a hand-held device. The electronic device 105 may be a mobile phone, a tablet, a laptop, so forth. In some implementations, the electronic device 105 may be worn by a user. For example, the electronic device 105 may be a watch, a head-mounted device (HMD), head-worn device (glasses), headphones, an ear mounted device, and so forth. In some implementations, functions of the device 105 are accomplished via two or more devices, for example a mobile device and base station or a head mounted device and an ear mounted device. Various capabilities may be distributed amongst multiple device, including, but not limited to power capabilities, CPU capabilities, GPU capabilities, storage capabilities, memory capabilities, visual content display capabilities, audio content production capabilities, and the like. The multiple devices that may be used to accomplish the functions of electronic device 105 may communicate with one another via wired or wireless communications.

According to some implementations, the electronic device 105 generates and presents an extended reality (XR) environment to one or more users during a communication session. People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

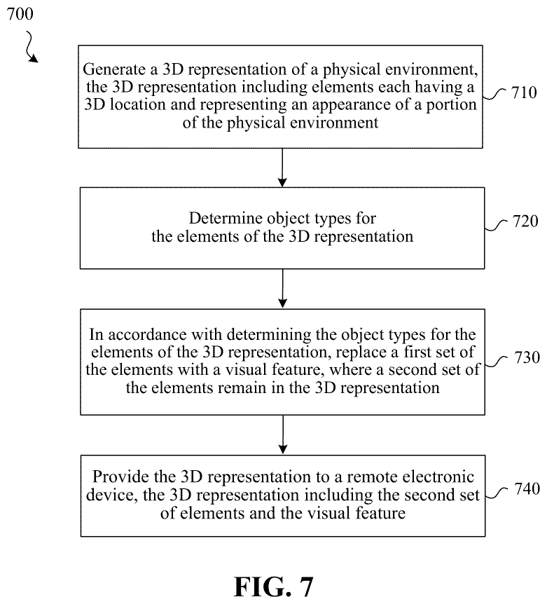

FIG. 7 is a flowchart illustrating a method 700 for generating and transmitting a 3D representation of a physical environment during a communication session. In some implementations, a device such as electronic device 105 performs method 700. In some implementations, method 700 is performed on a mobile device, desktop, laptop, HMD, ear-mounted device or server device. The method 700 is performed by processing logic, including hardware, firmware, software, or a combination thereof. In some implementations, the method 700 is performed on a processor executing code stored in a non-transitory computer-readable medium (e.g., a memory).

At block 710, the method 700 generates a three-dimensional (3D) representation (e.g., a 3D point cloud, a 3D mesh, etc.) of a physical environment, the 3D representation including elements (e.g., points of a point cloud or points or polygons of a mesh) each having a 3D location and representing an appearance (e.g., color) of a portion of the physical environment. In one example, a 3D point cloud of the room of a hosting user is generated during a communication session. In such a communication session, avatars or other user representations of the communication session may be (but need not be) positioned within the 3D representation as part of a providing a shared environment experience to multiple users.

A block 720, the method 700 determines object types (e.g., a semantic label such as “wall”) for the elements of the 3D representation. This may involve using a machine learning model or algorithm to provide scene understanding-based semantic labels (e.g., table, couch, wall, etc.) for the points of a point cloud or the points/polygons of a 3D mesh. For example, a scene understanding machine learning model or algorithm may identify types of points of the points clouds corresponding to furniture object types (e.g., couch, ottoman, chair, bench, table, coffee table, end table, bed, buffet, cabinet, wardrobe, etc.) and room perimeter object types (e.g., wall, ceiling, floor, nook, trey ceiling, etc.).

At block 730, in accordance with determining the object types for the elements of the 3D representation, the method 700 replaces a first set of the elements of the 3D representation that correspond to a first object type with a visual feature, where a second set of the elements of the 3D representation that do not correspond to the first object type remain in the 3D representation. In some implementations, which elements to replace is determined based on object type (e.g., furniture versus walls versus hand-held objects), distance (e.g., close to the user(s) or beyond a threshold distance), object size (e.g., only replacing objects larger than a threshold length, volume, etc.,), complexity (e.g., only replacing objects with solid or pattern surface appearance), and/or one or more other criteria.

In one example, the first set of elements that are replaced are elements associated with a perimeter region, e.g., a wall, floor, ceiling, etc., and are replaced with a visual feature this is a planar element. A planar element may be defined using location/orientation information (e.g., a 6 DOF pose) and information identifying shape type, size, color, texture, etc. In another example, this involves replacing room boundary elements (e.g., of walls, ceiling, floor) with a geometric shell, e.g., an empty 3D shape such as a 3D rectangle for a rectangular room. A shell may similarly be defined using location/orientation information (e.g., a 6 DOF pose) and information identifying shape type, size, color, texture, etc. FIGS. 1-3 illustrate replacing a first set of elements while a second set of elements remains within a 3D representation.

The color and/or texture of the visual feature may be determined based on assessing the physical environment, e.g., via texture matching, as illustrated in FIG. 4. For example, this may involve obtaining an image of the physical environment, identifying a portion of the image corresponding to the first set of elements, and generating an appearance characteristic of the visual feature based on the portion of the image (e.g., color, texture, lighting, etc.).

In some implementations, a visual feature corresponds to a window, door, glass wall, or other element through which light and/or extra-room content is visible. Such a visual feature may have a characteristic that corresponds to or is otherwise based upon the physical environment. For example, a window to an external (sunny) landscape may have a bright appearance corresponding to the lighter external environment. External content visible through such an element may be blurred or otherwise obscured to provide a sense of the general environment without revealing details, e.g., grass and landscaping may appear as a blurry green/brown region, the sky may appear as a blurry blue/white region, etc. Blurring and obscuring content may provide a more desirable user experience as well as provide sharing in accordance with the users' privacy requirements, preferences, consents, and permissions.

In some implementations, an edge treatment is performed to blend the appearance of point cloud points with nearby portions of a visual feature such as a planar element or shell.

At block, 740, the method 700 provides the 3D representation to a remote electronic device, the 3D representation including the second set of elements and the visual feature. In some implementations, the transmitting and/or receiving electronic device provides a view of the 3D representation. Providing such a view may include displaying the view of the 3D representation. Accordingly, for example, user views may be based on the remaining elements of a 3D representation, e.g., of the 3D point cloud, depicting the couch, curtains, tables, etc. and a geometric shape such as a semantic shell representing the boundary portions of a room.

FIG. 8 is a flowchart illustrating a method 800 for providing feedback in a scan of a physical environment during a communication session. In some implementations, a device such as electronic device 105 performs method 800. In some implementations, method 800 is performed on a mobile device, desktop, laptop, HMD, ear-mounted device or server device. The method 800 is performed by processing logic, including hardware, firmware, software, or a combination thereof. In some implementations, the method 800 is performed on a processor executing code stored in a non-transitory computer-readable medium (e.g., a memory).

At block 810, the method 800 obtains sensor data (e.g., images, depth data, motion, etc.) during a scan of a physical environment during a communication session. In some implementations, a 3D representation of the physical environment is updated during the scanning based on receiving sensor data corresponding to previously unscanned parts of the physical environment. For example, the user may move or reorient the device such that the device's sensors are oriented towards portions of the physical environment that were not previously scanned. In some implementations, a user intentionally moves and orients the device to try to capture a particular region or regions of the physical environment. In another example, the scanning occurs without an explicit intention of performing scanning, as the user naturally moves and reorients the device during the communication session.

At block, 820, the method 800 alters a 3D representation (e.g., a 3D point cloud) of the physical environment during the scan based on the sensor data, where the altering changes which portions of the physical environment are represented in the 3D representation.

At block 830, in accordance with altering the 3D representation, the method 800 updates a graphical indication in a view of the physical environment provided during the scan, the graphical indication corresponding to a boundary between a first portion of the physical environment represented in the 3D representation and a second portion of the physical environment unrepresented in the 3D representation. FIG. 6 provides an illustration of a graphical indication corresponding to a boundary between a first portion of a physical environment represented in a 3D representation and a second portion not represented in the 3D representation. The graphical indication may move as additional sensor data corresponding to previously unscanned portions of the physical environment are obtained during the scan.

In some implementations, feedback provided during a scanning process involves applying a visual characteristic to distinguish the first portion and the second portion, e.g., via a painting effect that changes the appearance/color/points used to depict different portions of a physical environment during a scan.

In some implementations, not all scanned portions of a physical environment are included in a 3D representation and/or transmitted to other users involved in a communication session. For example, the method 800 may involve receiving an identification (e.g., of an object or boundary) that limits which portions of the physical environment are represented in the 3D representation and transmitted during the communication session. A user may draw a line or 3D boundary and exclude all portions of the physical environment on one side of the boundary from inclusion in a shared/transmitted 3D representation. All 3D modeling and sharing/transmitting should be performed in accordance with user privacy requirements, preferences, permissions, and consent.

The method 800, at block 840, transmits the 3D representation during the communication session. The 3D representation that is transmitted during the communication session may be altered (e.g., as the 3D representation is updated it may be re-transmitted) to share previously unscanned parts of the physical environment based on the previously unscanned parts being scanned during the scan.

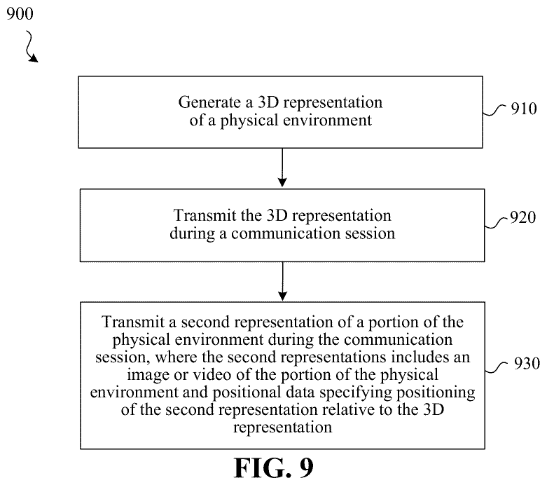

FIG. 9 is a flowchart illustrating a method for provide an additional aspect of an object depicted in a 3D representation during a communication session. In some implementations, a device such as electronic device 105 performs method 900. In some implementations, method 900 is performed on a mobile device, desktop, laptop, HMD, ear-mounted device or server device. The method 900 is performed by processing logic, including hardware, firmware, software, or a combination thereof. In some implementations, the method 900 is performed on a processor executing code stored in a non-transitory computer-readable medium (e.g., a memory).

At block 910, the method 900 generates a 3D representation (e.g., a 3D point cloud, mesh, etc.) of a physical environment. At block 920, the method 900 transmits the 3D representation during a communication session. This may enable a receiving electronic device to provide a view of the 3D representation.

At block 930, the method 900 transmits a second representation of a portion of the physical environment during the communication session, where the second representation comprises an image or video of the portion of the physical environment and positional data specifying positioning of the second representation relative to the 3D representation. The second representation may represent an aspect (e.g., more details, photo quality images, live, etc.) of the portion not represented by the 3D representation. The second representation may be image data, real-time data, camera pass through images, etc.

This transmitting may involve identifying input (e.g., the host pointing at the record player, a user looking at a particular object for more than a threshold amount of time, etc.), identifying an object or portion of the physical environment based on the input, and providing the second representation to represent additional content associated with the identified object or portion of the physical environment.

The method 900 may provide a view of the physical environment based on the 3D representation, where the view includes the second representation of the portion of the physical environment. FIG. 5 provides an illustration of a secondary representation (e.g., 520 showing a view of coffee cup 180) included within a 3D representation (e.g., 3D representation of physical environment 100). In some implementations, the view may be provided (e.g., displayed) by the same device that generated the 3D representation at block 910. In some implementations, the 3D representation and/or additional representation may be transmitted to/shared with one or more other electronic devices that display views based on receiving the transmitted information. In other implementations, the view may be provided (e.g., displayed) by other devices that are part of the communication session.

The second representation may be positioned based on a position of a corresponding representation of the portion in the 3D representation, e.g., in front of or in place of corresponding points of the point cloud or points/polygons of a 3D mesh corresponding to the associated object or portion of the physical environment. The second representation may be positioned based on the viewer's viewpoint within the 3D environment to provide a desirable viewing angle, e.g., even if that angle differs somewhat from the object's actual orientation within the physical environment. In other examples, the second representation can be displayed in place of the presenting user (or avatar), at a predefined offset from the avatar, overlaid on the avatar, in a location controlled by the viewing user (e.g., app window, hand, etc.), or using alternative or additional presentation location selection criteria.

Moreover, live content may be captured within sensor data and used to provide live information about a particular object or environment portion. If the sensors are not currently obtaining live data, a most recent live image or sequence may be provided until additional live sensor data is available.

The sharing/transmitting feature illustrated in FIG. 9 may be implemented as a selective share feature (e.g., a point and share feature) that enables a user to selectively share enhanced environment information during a shared environment session in which hardware and/or communication constraints restrict or prevent the sharing of high fidelity and/or live information about all aspects of a physical environment.

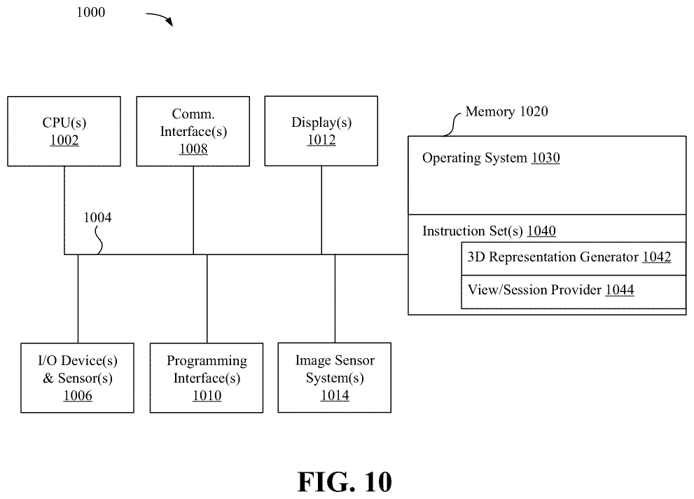

FIG. 10 is a block diagram of electronic device 1000. Device 1000 illustrates an exemplary device configuration for electronic device 105. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1010, one or more output device(s) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1012 include one or more displays configured to present a view of a 3D environment to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 comprises a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include 3D representation generator instruction set 1042 configured to, upon execution, generate and/or transmit a representation of a physical environment, for example, during a communication session, as described herein. The instruction set(s) 1040 further include view/session provider instruction set 1044 configured to, upon execution, determine to provide a view of a 3D environment as described herein. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, FIG. 10 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

1. A method comprising:
at a processor:
generating a three-dimensional (3D) representation of a physical environment, the 3D representation comprising elements each having a 3D location and representing an appearance of a portion of the physical environment;
determining object types for the elements of the 3D representation;
in accordance with determining the object types for the elements of the 3D representation, replacing a first set of the elements of the 3D representation that correspond to a first object type with a visual feature, wherein a second set of the elements of the 3D representation that do not correspond to the first object type remain in the 3D representation; and
providing the 3D representation to a remote electronic device, the 3D representation comprising the second set of elements and the visual feature.

2. The method of claim 1, wherein the remote electronic device provides a view of the 3D representation, the view comprising the second set of elements and the visual feature.

3. The method of claim 1, wherein the 3D representation is a point cloud and the elements are points.

4. The method of claim 1, wherein determining object types for the elements of the 3D representation comprises using a machine learning model to provide a scene understanding of the physical environment.

5. The method of claim 1, wherein the object types include furniture object types and room perimeter object types.

6. The method of claim 1, wherein the first object type is a room perimeter object type and the visual feature comprises one or more planar elements.

7. The method of claim 1, wherein the first object type is a room perimeter object type and the visual feature comprises a geometric element corresponding to at least a portion of a perimeter of the physical environment.

8. The method of claim 1 further comprising:
obtaining an image of the physical environment;
identifying a portion of the image corresponding to the first set of elements; and
generating an appearance characteristic of the visual feature based on the portion of the image.

9. The method of claim 1, wherein the visual feature is defined using less data than the first set of elements.

10. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
generating a three-dimensional (3D) representation of a physical environment, the 3D representation comprising elements each having a 3D location and representing an appearance of a portion of the physical environment;
determining object types for the elements of the 3D representation;
in accordance with determining the object types for the elements of the 3D representation, replacing a first set of the elements of the 3D representation that correspond to a first object type with a visual feature, wherein a second set of the elements of the 3D representation that do not correspond to the first object type remain in the 3D representation; and
providing the 3D representation to a remote electronic device, the 3D representation comprising the second set of elements and the visual feature.

11. The system of claim 10, wherein the 3D representation is a point cloud and the elements are points.

12. The system of claim 10, wherein determining object types for the elements of the 3D representation comprises using a machine learning model to provide a scene understanding of the physical environment.

13. The system of claim 10, wherein the object types include furniture object types and room perimeter object types.

14. The system of claim 10, wherein the first object type is a room perimeter object type and the visual feature comprises one or more planar elements.

15. The system of claim 10, wherein the first object type is a room perimeter object type and the visual feature comprises a geometric element corresponding to at least a portion of a perimeter of the physical environment.

16. The system of claim 10 further comprising:
obtaining an image of the physical environment;
identifying a portion of the image corresponding to the first set of elements; and
generating an appearance characteristic of the visual feature based on the portion of the image.

17. The system of claim 10, wherein the visual feature is defined using less data than the first set of elements.

18. The system of claim 10, wherein the view of the 3D representation is provided to an electronic device during a communication session.

19. A non-transitory computer-readable storage medium storing program instructions executable via one or more processors to perform operations comprising:
generating a three-dimensional (3D) representation of a physical environment, the 3D representation comprising elements each having a 3D location and representing an appearance of a portion of the physical environment;
determining object types for the elements of the 3D representation;
in accordance with determining the object types for the elements of the 3D representation, replacing a first set of the elements of the 3D representation that correspond to a first object type with a visual feature, wherein a second set of the elements of the 3D representation that do not correspond to the first object type remain in the 3D representation; and
providing the 3D representation to a remote electronic device, the 3D representation comprising the second set of elements and the visual feature.

20. The non-transitory computer-readable storage medium of claim 19, wherein the remote electronic device provides a view of the 3D representation, the view comprising the second set of elements and the visual feature.

21-76. (canceled)
